(19) United States
(12) Patent Application Publication
(10) Pub. No.: US 2024/0403571 A1
(43) Pub. Date: Dec. 5, 2024

(54) MACHINE LEARNING METHOD AND INFORMATION PROCESSING APPARATUS

(71) Applicant: Fujitsu Limited, Kawasaki-shi (JP)

(72) Inventor: Thang Duy DANG, Yokohama (JP)

(73) Assignee: Fujitsu Limited, Kawasaki-shi (JP)

(21) Appl. No.: 18/626,371

(22) Filed: Apr. 4, 2024

(30) Foreign Application Priority Data
May 31, 2023 (JP) 2023-090178

(51) Int. Cl. G06F 40/58; G06F 40/242; G06N 20/00

(52) U.S. Cl. CPC G06F 40/58; G06F 40/242; G06N 20/00

(57) ABSTRACT

An information processing apparatus acquires word dictionary data in which strings each representing one of multiple words are mapped to codes each identifying one of the multiple words. The information processing apparatus converts text data into encoded text data by encoding words included in the text data based on the word dictionary data. The information processing apparatus initializes parameters included in a machine learning model based on the word dictionary data and the encoded text data. The information processing apparatus runs a learning process to train, based on the encoded text data, the machine learning model from which the word dictionary data has been detached after the initialization.

### CROSS-REFERENCE TO RELATED APPLICATION

This application is based upon and claims the benefit of priority of the prior Japanese Patent Application No. 2023-090178, filed on May 31, 2023, the entire contents of which are incorporated herein by reference.

### FIELD

The embodiments discussed herein relate to a machine learning method and information processing apparatus.

### BACKGROUND

Computers may engage in natural language processing tasks, such as machine translation and question answering, using a natural language processing model that processes text data written in natural language. Computers may generate the natural language processing model through machine learning, using sample text given as training data.

Such a natural language processing model may be neural networks. In addition, the natural language processing model may convert words included in input data into distributed representation vectors expressed in multidimensional numerical values, and may calculate features from the distributed representation vectors. Natural language processing models usually depend on word dictionary data that represents vocabulary of a target natural language.

There is a proposed machine translation apparatus for generating a pseudo bilingual corpus by back-translating text in a target language and training a machine translation model using both the generated pseudo bilingual corpus and a small and highly accurate basic bilingual corpus.

Japanese Laid-open Patent Publication No. 2019-153023

### SUMMARY

According to an aspect, there is provided a machine learning method including acquiring, by a processor, word dictionary data in which strings each representing one of a plurality of words used in natural language are mapped to codes each identifying one of the plurality of words; converting, by the processor, text data written in the natural language into encoded text data by encoding words included in the text data based on the word dictionary data; initializing, by the processor, parameters included in a machine learning model based on the word dictionary data and the encoded text data; and running, by the processor, a learning process to train, based on the encoded text data, the machine learning model from which the word dictionary data has been detached after the initializing of the parameters.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processor according to a first embodiment;

FIG. 2 illustrates a hardware example of an information processor of a second embodiment;

FIG. 3 illustrates an example of a structure of a natural language processing model;

FIG. 4 illustrates an example of text and encoded text;

FIG. 5 illustrates an example of a word dictionary and embedding dictionary;

FIG. 6 illustrates an example of conversion of prediction results using the word dictionary;

FIG. 7 is graphs illustrating an example of training time and prediction accuracy;

FIG. 8 is a block diagram illustrating an example of functions of the information processor; and

FIG. 9 is a flowchart illustrating an example of a machine learning procedure.

### DESCRIPTION OF EMBODIMENTS

Because the vocabulary of natural language contains a large number of words, word dictionary data including string representations of the words is large in size. For this reason, training a natural language processing model incorporating the word dictionary data as it is involves heavy machine learning, which may result in long training time.

Several embodiments will be described below with reference to the accompanying drawings.

### (a) First Embodiment

A first embodiment is described hereinafter.

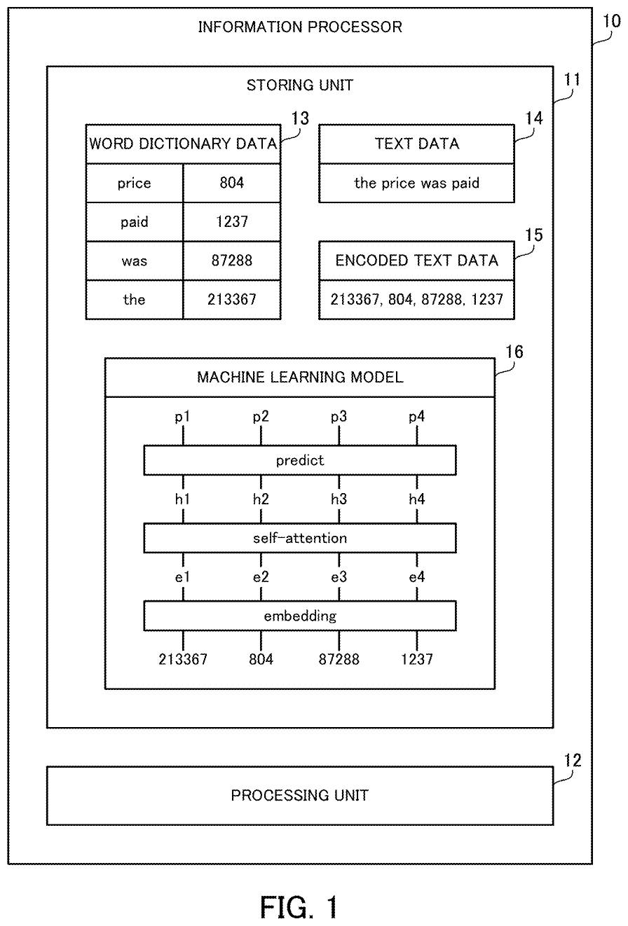

FIG. 1 illustrates an information processor according to the first embodiment.

An information processor 10 of the first embodiment trains a natural language processing model through machine learning. The information processor 10 may be a client device or server device. The information processor 10 may be called a computer, machine learning device, or natural language processor.

The information processor 10 includes a storing unit 11 and a processing unit 12. The storing unit 11 may be volatile semiconductor memory, such as random access memory (RAM), or a non-volatile storage device, such as a hard disk drive (HDD) or flash memory.

The processing unit 12 is, for example, a processor, such as a central processing unit (CPU), graphics processing unit (GPU), or digital signal processor (DSP). Note however that the processing unit 12 may include an electronic circuit, such as an application specific integrated circuit (ASIC) or field programmable gate array (FPGA). The processor executes programs stored in memory, such as RAM, (or stored in the storing unit 11). The term “multiprocessor”, or simply “processor”, may be used to refer to a set of multiple processors.

The storing unit 11 stores word dictionary data 13 and text data 14. The word dictionary data 13 maps character strings (hereinafter simply referred to as “strings”) each representing one of multiple words used in natural language to codes each identifying one of the multiple words. The codes are, for example, non-negative integers. The word dictionary data 13 may be an array with the multiple words simply aligned. In this case, the codes may be indices indicating the order of the multiple words. Each index indicates the position of the mapped word from the beginning within the word dictionary data 13.

The word dictionary data 13 may be monolingual dictionary data listing words used in a single natural language, or may be multilingual dictionary data listing words used in multiple natural languages. The information processor 10 may acquire already-existing word dictionary data from outside the information processor 10 and use it as the word dictionary data 13. Alternatively, the information processor 10 may generate the word dictionary data 13 by extracting words from the text data 14 or other text data. In general, the word dictionary data 13 is large in size, containing a large number of words.

The text data 14 includes one or more sentences written in natural language. The text data 14 uses words contained in the word dictionary data 13. In the text data 14, the words are written as strings. The text data 14 may include multiple sentences written in different natural languages. The text data 14 is used as training data in machine learning to train a machine learning model 16. Depending on how to train the machine learning model 16, the text data 14 may be with or without labels. The labels indicate correct outputs of the machine learning model 16. Each label may indicate the class to which a given word belongs, or may indicate a translated sentence or answer sentence corresponding to a given sentence.

The processing unit 12 trains the machine learning model 16 using the word dictionary data 13 and the text data 14. At this time, the processing unit 12 encodes the words included in the text data 14 based on the word dictionary data 13. For example, the processing unit 12 divides the sentences included in the text data 14 into multiple tokens. Each token includes a string representing a word. The processing unit 12 searches the word dictionary data 13 for the code which is mapped to the string represented by each token, and replaces the string of the token with the code.

Herewith, the processing unit 12 converts the text data 14 into encoded text data 15. The encoded text data 15 includes an array of codes. For example, the encoded text data 15 is binary data including an array of non-negative integers.

In addition, the processing unit 12 initializes parameters included in the machine learning model 16 based on the word dictionary data 13 and the encoded text data 15. The machine learning model 16 is a natural language processing model for processing text data written in natural language. The machine learning model 16 is, for example, neural networks. The machine learning model 16 may include neural networks called transformer encoders, and may be a bidirectional encoder representations from transformers (BERT).

The machine learning model 16 may include an embedding layer for converting codes included in input encoded text data into distributed representation vectors. Each distributed representation vector is a numerical vector with a certain number of dimensions (for example, 512 dimensions), in which the certain number of numerical values are aligned. Similar distributed representation vectors are usually assigned to words with similar meanings. The embedding layer may calculate the distributed representation vectors from the codes using weights included in a neural network. Alternatively, the embedding layer may retrieve the distributed representation vectors corresponding to the individual codes from a lookup table. The lookup table is distributed representation dictionary data that maps codes and distributed representation vectors to each other. A distributed representation vector mapped to a given code is a distributed representation of a word mapped to the code in the word dictionary data 13.

The machine learning model 16 may include neural networks such as a self-attention layer and feedforward layer. These layers convert distributed representation vectors into other feature vectors. Each feature vector is a numerical vector with a certain number of dimensions, in which the certain number of numerical values are aligned. These feature vectors may be called hidden state vectors.

The machine learning model 16 may also include a prediction layer for predicting words from feature vectors. For example, the prediction layer calculates a probability distribution representing the prediction probability of each of multiple words from a feature vector and distributed representation dictionary data. The prediction layer may obtain the probability distribution by calculating the product between the feature vector and a matrix corresponding to the distributed representation dictionary data. For example, the prediction layer determines the word with the highest prediction probability in the probability distribution as the word to be output.

In initialization of the machine learning model 16, for example, the processing unit 12 initializes parameters of the machine learning model 16 according to the size of the word dictionary data 13 and the size of the text data 14. The embedding layer may use a neural network, the input size of which corresponds to the number of words contained in the word dictionary data 13, and may use distributed representation dictionary data containing the same number of records as the word dictionary data 13. In addition, the prediction layer may use a matrix corresponding to the distributed representation dictionary data, and may calculate a probability distribution which includes the prediction probability of each word contained in the word dictionary data 13. Therefore, the parameters of the machine learning model 16 may depend on the number of words contained in the word dictionary data 13.

A tensor representing input data to be entered to each layer of the machine learning model 16 may have a size depending on the number of dimensions of the feature vectors and the maximum number of tokens to be entered at one time. Therefore, the parameters of the machine learning model 16 may depend on the number of codes for one batch, included in the encoded text data 15.

Note that the processing unit 12 may train the embedding layer for converting codes into distributed representation vectors together with other layers in a learning process to be described later. Herewith, the distributed representation vector assigned to each word is also optimized through the learning process. In that case, the processing unit 12 may initialize the weights of the neural network included in the embedding layer to random numerical values. Alternatively, the processing unit 12 may initialize distributed representation vectors contained in the distributed representation dictionary data used as a lookup table to random numerical vectors.

The processing unit 12 may acquire distributed representation vectors to be assigned to individual words from an existing language model trained in advance. In that case, for example, the processing unit 12 acquires the distributed representation vectors of the words contained in the word dictionary data 13, and registers the acquired distributed representation vectors and codes for identifying the individual words in the distributed representation dictionary data in such a manner that the acquired distributed representation vectors are mapped one-to-one to the codes. The processing unit 12 need not train the embedding layer in the learning process to be described later. Note however that the processing unit 12 may perform fine tuning which uses the distributed representation vectors acquired from the existing language model as initial values and updates the distributed representation values in the learning process.

The above-described initialization may be accomplished using a machine learning library application programming interface (API), which is a software module for assisting machine learning. For example, the processing unit 12 calls the API to thereby attach the word dictionary data 13 and the encoded text data 15 to the machine learning model 16 and initializes the parameters using the word dictionary data 13 and the encoded text data 15. In this case, the word dictionary data 13 is incorporated into the machine learning model 16 immediately after the initialization.

Subsequently, the processing unit 12 executes a learning process for training the machine learning model 16 using the encoded text data 15 as training data. For example, the processing unit 12 masks some codes included in the encoded text data 15, and updates the values of the parameters of the machine learning model 16 in such a manner that the machine learning model 16 predicts the original codes before masking. The code masking is achieved, for example, by replacing codes to be masked with invalid numerical values which are not mapped to words.

At this time, for example, the processing unit 12 calculates the error for the masked codes between a predicted vector representing the probability distribution calculated by the prediction layer and the correct vector, and updates the weights within the neural networks in such a manner as to reduce the error by error backpropagation. The predicted vector is a numerical vector listing prediction probabilities of multiple codes. The correct vector is a numerical vector in which the numerical value of the dimension corresponding to the correct code before masking is set to 1 and the numerical values of the remaining dimensions are all set to 0.

For the learning process, the processing unit 12 detaches the word dictionary data 13 from the machine learning model 16 after the initialization, and then executes the learning process. After the parameter initialization, the machine learning model 16 is able to perform a series of calculation using the codes and distributed representation vectors. The processing unit 12 is also able to perform error calculation using the codes and distribution representation vectors and run parameter updating algorithms such as error backpropagation.

On the other hand, if the word dictionary data 13 is incorporated into the machine learning model 16, various additional processes may be performed on the word dictionary data 13 even during the learning process. For example, the processing unit 12 may load the word dictionary data 13 into memory and hold it therein. When using a GPU for machine learning, the word dictionary data 13 may be loaded into GPU memory. The machine learning model 16 being large in size may lead to increased load of the learning process. In view of the above, the word dictionary data 13 is detached to thereby reduce the load of the learning process.

The processing unit 12 detaches the word dictionary data 13 from the machine learning model 16, for example, after the initialization and before the start of the learning process. The detachment of the word dictionary data 13 may be implemented using a machine learning library API. For example, the processing unit 12 releases the link between the word dictionary data 13 and the machine learning model 16 by calling the API. When the word dictionary data 13 is detached, for example, loading and referencing the word dictionary data 13 are suppressed during the learning process.

Note however that, when the word dictionary data 13 is detached, the machine learning model 16 does not perform inverse-conversion from codes to strings. On the other hand, when testing the machine learning model 16, the user may want to check predicted words as strings. In view of this, after the learning process, the processing unit 12 may convert the prediction results from codes into strings using the word dictionary data 13. At this time, the processing unit 12 may incorporate again the word dictionary data 13 into the machine learning model 16. In addition, the trained machine learning model 16 including the word dictionary data 13 may be distributed.

As explained above, the information processor 10 of the first embodiment acquires the word dictionary data 13 which maps strings each representing one of multiple words to codes each identifying one of the words. The information processor 10 converts the text data 14 into the encoded text data 15 by encoding words included in the text data 14 based on the word dictionary data 13. Using the word dictionary data 13 and the encoded text data 15, the information processor 10 initializes the parameters included in the machine learning model 16. The information processor 10 runs a learning process to train, based on the encoded text data 15, the machine learning model 16 from which the word dictionary data 13 has been detached after the initialization.

This allows the size of the machine learning model 16 to be kept small during the learning process, and therefore reduces the load of the learning process, which in turn shortens the training time. Note that the update of the parameter values included in the machine learning model 16 is capable of being implemented without reference to the word dictionary data 13. Therefore, downsizing the machine learning model 16 does not affect the preservation of the prediction accuracy of the machine learning model 16.

Note that the information processor 10 may acquire prediction result data including the code of a given word by entering input data to the machine learning model 16 after the learning process, and may convert the code included in the prediction result data into a string based on the word dictionary data 13. This allows the user to check the predicted word as a string, thus improving the ease of understanding of the prediction results.

In addition, at the time of the initialization, the information processor 10 may set, in the machine learning model 16, distributed representation data in which distributed representation vectors to be assigned to individual words are mapped to codes. The machine learning model 16 may include an embedding layer that converts the codes included in the encoded text data 15 into the distributed representation vectors. Herewith, the machine learning model 16 is able to perform highly accurate natural language processing using the distributed representation vectors. Further, the machine learning model 16 is able to perform calculations using the codes and the distributed representation vectors without referring to the word dictionary data 13.

### (b) Second Embodiment

A second embodiment is described next.

An information processor 100 of the second embodiment runs machine learning to train a natural language processing model. Using the trained natural language processing model, the information processor 100 also runs natural language processing tasks. Note however that the machine learning and the natural language processing tasks may be performed separately by different information processors. The information processor 100 may be a client device or server device. The information processor 100 may be called a computer, machine learning device, or natural language processor. The information processor 100 of the second embodiment corresponds to the information processor 10 of the first embodiment.

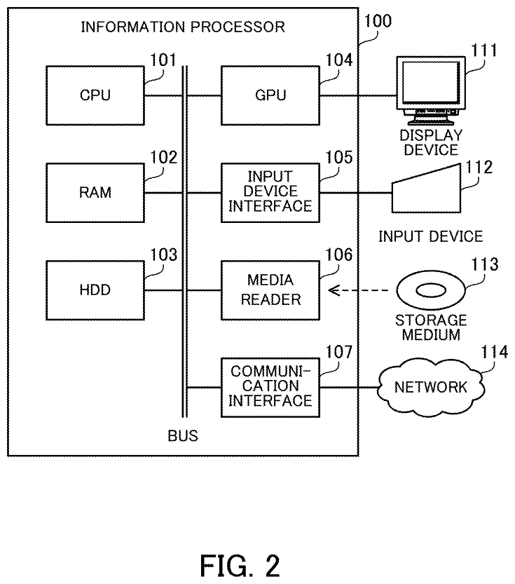

FIG. 2 illustrates a hardware example of the information processor of the second embodiment.

The information processor 100 includes a CPU 101, a RAM 102, an HDD 103, a GPU 104, an input device interface 105, a media reader 106, and a communication interface 107, which are all connected to a bus. The CPU 101 corresponds to the processing unit 12 of the first embodiment. The RAM 102 or the HDD 103 corresponds to the storing unit 11 of the first embodiment.

The CPU 101 is a processor configured to execute program instructions. The CPU 101 reads out programs and data stored in the HDD 103, loads them into the RAM 102, and executes the loaded programs. Note that the information processor 100 may include two or more processors.

The RAM 102 is volatile semiconductor memory for temporarily storing therein programs to be executed by the CPU 101 and data to be used by the CPU 101 for its computation. The information processor 100 may be provided with a different type of volatile memory other than RAM.

The HDD 103 is a non-volatile storage device to store therein software programs, such as an operating system (OS), middleware, and application software, as well as various types of data. The information processor 100 may be provided with a different type of non-volatile storage device, such as flash memory or a solid state drive (SSD).

The GPU 104 performs image processing in cooperation with the CPU 101, and displays video images on a screen of a display device 111 coupled to the information processor 100. The display device 111 may be a cathode ray tube (CRT) display, a liquid crystal display (LCD), an organic electro-luminescence (OEL) display, or a projector. An output device, such as a printer, other than the display device 111 may be connected to the information processor 100.

In addition, the GPU 104 may be used as a general-purpose computing on graphics processing unit (GPGPU). The GPU 104 may execute programs according to instructions from the CPU 101. The information processor 100 may have volatile semiconductor memory other than the RAM 102 as GPU memory.

The input device interface 105 receives an input signal from an input device 112 connected to the information processor 100. Various types of input devices may be used as the input device 112, for example, a mouse, a touch panel, or a keyboard. Multiple types of input devices may be connected to the information processor 100.

The media reader 106 is a device for reading programs and data recorded on a storage medium 113. The storage medium 113 may be, for example, a magnetic disk, an optical disk, or semiconductor memory. Examples of the magnetic disk include a flexible disk (FD) and HDD. Examples of the optical disk include a compact disc (CD) and digital versatile disc (DVD). The media reader 106 copies the programs and data read out from the storage medium 113 to a different storage medium, for example, the RAM 102 or the HDD 103. The read programs may be executed by the CPU 101.

The storage medium 113 may be a portable storage medium and used to distribute the programs and data. In addition, the storage medium 113 and the HDD 103 may be referred to as computer-readable storage media.

The communication interface 107 communicates with different information processors via a network 114. The communication interface 107 may be a wired communication interface connected to a wired communication device, such as a switch or router, or may be a wireless communication interface connected to a wireless communication device, such as a base station or access point.

Next described is a natural language processing model. The natural language processing model of the second embodiment may be used for various natural language processing tasks, such as machine translation, sentiment analyses, and recommendation systems. Such natural language processing tasks may be implemented in a data center or provided as an application service via a network. Machine learning for training the natural language processing model may be run in a data center or provided as an application service via a network.

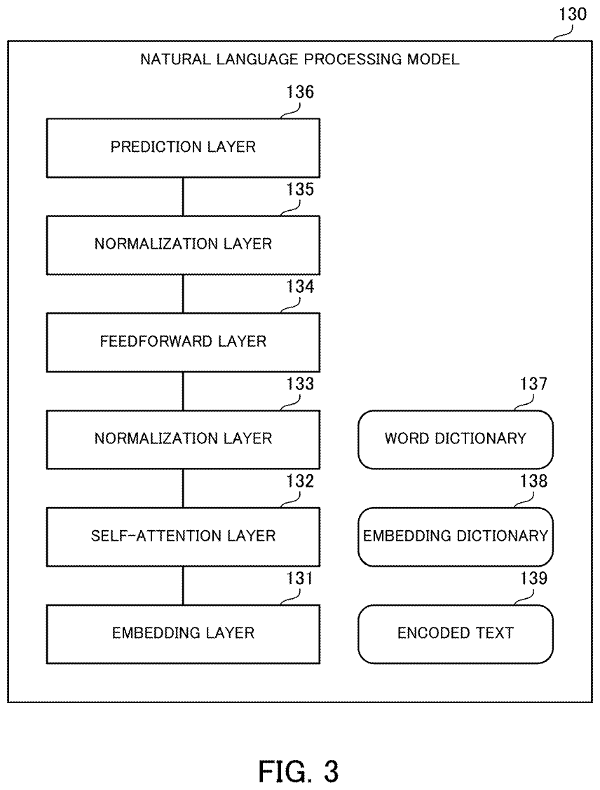

FIG. 3 illustrate an example of a structure of a natural language processing model.

A natural language processing model 130 is a machine learning model including neural networks. The natural language processing model 130 includes a transformer encoder that implements a self-attention mechanism. The natural language processing model 130 may be BERT. The transformer encoder converts multiple feature vectors corresponding to multiple tokens included in text into multiple other vectors corresponding to the multiple tokens, taking into consideration the relationship between the multiple feature vectors.

The natural language processing model 130 includes an embedding layer 131, a self-attention layer 132, a normalization layer 133, a feedforward layer 134, a normalization layer 135, and a prediction layer 136. The natural language processing model 130 may also include a word dictionary 137, an embedding dictionary 138, and encoded text 139.

The word dictionary 137 is dictionary data in which each of multiple words used in natural language is represented as a string. The word dictionary 137 may be called raw dictionary. Each word contained in the word dictionary 137 is identified by a non-negative integer index which indicates the position of the word from the beginning. The word dictionary 137 may be a multilingual dictionary that includes words in multiple natural languages. The word dictionary 137 is generated by extracting words from sample text for machine learning.

The embedding dictionary 138 is dictionary data which indicates distributed representation vectors each assigned to one of the multiple words given in the word dictionary 137. The distributed representation vectors are numerical vectors each including numerical values with a certain number of dimensions (for example, 512 dimensions). Words with similar meanings are usually assigned similar distributed representation vectors. Converting words into distributed representation vectors is sometimes called embedding. In the embedding dictionary 138, distributed representation vectors corresponding to individual words are identified by the same indices as in the word dictionary 137. When the index of a given word is k in the word dictionary 137, the index of the distributed representation vector corresponding to the word is also k in the embedding dictionary 138.

The encoded text 139 is binary data obtained by encoding text written in natural language using the indices of the word dictionary 137. The original text includes one or more sentences each containing multiple words represented as strings. The sentences included in the text are divided into multiple tokens using a tokenizer. One token usually corresponds to one word. Note however that one word may be divided into two or more subwords. Each token is replaced with an index indicated by the word dictionary 137. Herewith, the text represented by strings is converted into the encoded text 139 represented by an array of indices.

The embedding layer 131 is a neural network for converting each index included in the encoded text 139 into a distributed representation vector. The embedding layer 131 converts a non-negative integer functioning as an index into a one-hot vector. The one-hot vector is a vector with the number of dimensions corresponding to the number of words contained in the word dictionary 137. In the one-hot vector, the dimension indicated by the corresponding index is set to 1 and the remaining dimensions are all set to zero. The embedding layer 131 uses the one-hot vector as an input to the neural network, and calculates a distributed representation vector with a certain number of dimensions, using weights of the neural network.

Note however that, if the embedding dictionary 138 is available, the embedding layer 131 may extract distributed representation vectors corresponding to the individual indices from the embedding dictionary 138 instead of calculating the distributed representation vectors using the neural network. In this case, the embedding dictionary 138 is used as a lookup table.

Note that the embedding layer 131 may be trained together with the self-attention layer 132 and the feedforward layer 134. In this case, during machine learning, the weights of the neural network included in the embedding layer 131 as parameters change, and therefore the distributed representation vector calculated from each index changes. In that case, the weights of the embedding layer 131 may be initialized to random numerical values at the start of the machine learning.

The embedding layer 131 may be pre-trained before machine learning for training the self-attention layer 132 and the feedforward layer 134. The distributed representation vectors included in the embedding dictionary 138 may be those obtained from an existing language model. For example, the information processor 100 may extract the distributed representation vectors of the individual words contained in the word dictionary 137 from an existing language model and register them in the embedding dictionary 138.

Based on the position of each token contained in the encoded text 139, the embedding layer 131 calculates a position vector with the same number of dimensions as the distributed representation vector by position encoding. The position of a given token indicates the number of the token from the beginning of a token string (e.g., from the beginning of a sentence). The position vector is a numerical vector including numerical values with a certain number of dimensions, and is calculated using, for example, a sine or cosine function. The embedding layer 131 calculates a feature vector corresponding to each token by adding the position vector to the distributed representation vector. The number of dimensions of this feature vector is the same as that of the distributed representation vector.

The self-attention layer 132 receives multiple feature vectors corresponding to multiple tokens contained in the encoded text 139. The self-attention layer 132 converts the feature vector corresponding to a given token in the following manner.

The self-attention layer 132 converts the feature vector of the token of interest into a vector called query using a query coefficient matrix. The self-attention layer 132 also converts the feature vector of each of the multiple tokens into a vector called key using a key coefficient matrix. The self-attention layer 132 calculates the inner product of the query and the key of each token to thereby obtain an attention score of the token of interest. The attention score indicates the importance of each of the multiple tokens for the token of interest.

In addition, the self-attention layer 132 converts the feature vector of each of the multiple tokens into a vector called value using a value coefficient matrix. The self-attention layer 132 weights the values of the multiple tokens by the attention scores and adds them up. What is obtained in this manner is the converted feature vector of the token of interest. Coefficients included in the query coefficient matrix, those included in the key coefficient matrix, and those included in the value coefficient matrix are parameters optimized through machine learning.

The normalization layer 133 scales numerical values included in the feature vectors output from the self-attention layer 132 so as to follow a certain probability distribution. The certain probability distribution is, for example, a probability distribution with a mean of 0 and a variance of 1. The normalization is performed collectively on the multiple feature vectors corresponding to the multiple tokens.

The feedforward layer 134 converts each feature vector output from the normalization layer 133 into a different type of feature vector using a neural network. The number of dimensions of the input feature vector and that of the output feature vector may be the same. The feedforward layer 134 processes the feature vector of each token independently of the feature vectors of other tokens. Weights of the neural network are parameters optimized through machine learning.

The normalization layer 135 scales numerical values included in the feature vectors output from the feedforward layer 134 so as to follow a certain probability distribution. The certain probability distribution is, for example, a probability distribution with a mean of 0 and a variance of 1. The normalization is performed collectively on the multiple feature vectors corresponding to the multiple tokens. Note that the self-attention layer 132, the normalization layer 133, the feedforward layer 134, and the normalization layer 135 may be repeated multiple times.

The prediction layer 136 predicts, from the feature vector of each token output from the normalization layer 135, the index of the word associated with the token. For example, when the indices of some of the multiple tokens included in the encoded text 139 are masked at the input to the embedding layer 131, the prediction layer 136 predicts each masked index. Herewith, the self-attention layer 132 and the feedforward layer 134 are trained to calculate the feature vector of a given token by considering the context of the surrounding tokens.

For example, the prediction layer 136 calculates the product of the feature vector of each token and a matrix corresponding to the embedding dictionary 138 to thereby obtain a probability distribution including a prediction probability of each of the multiple indices. The prediction layer 136 predicts the index with the highest prediction probability amongst the multiple indices as the index of the masked token.

Optimization of the parameters included in the natural language processing model 130 is implemented through error backpropagation. The information processor 100 calculates, for a masked token, the error between a predicted vector indicating the probability distribution obtained by the prediction layer 136 and a one-hot vector indicating the correct index. The information processor 100 propagates error information in the direction from the prediction layer 136 to the embedding layer 131, then calculates an error gradient of each parameter, and updates, based on the calculated error gradients, the parameter values in such a manner as to reduce the error.

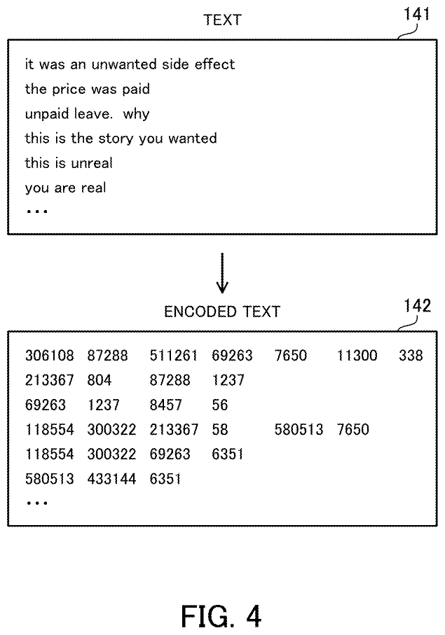

FIG. 4 illustrates an example of text and encoded text.

Text 141 is text data written in natural language. The text 141 is used for machine learning to train a natural language processing model. The information processor 100 divides sentences included in the text 141 into multiple tokens. For the token division, software called a tokenizer is used, which is created in advance for each natural language. The information processor 100 removes duplicate words from a set of tokens and sorts multiple words according to a certain standard, to thereby generate a word dictionary in which each word is given an index.

The information processor 100 generates encoded text 142 by replacing strings of words included in the text 141 with the indices indicated by the word dictionary. The encoded text 142 is equivalent to the encoded text 139 described above.

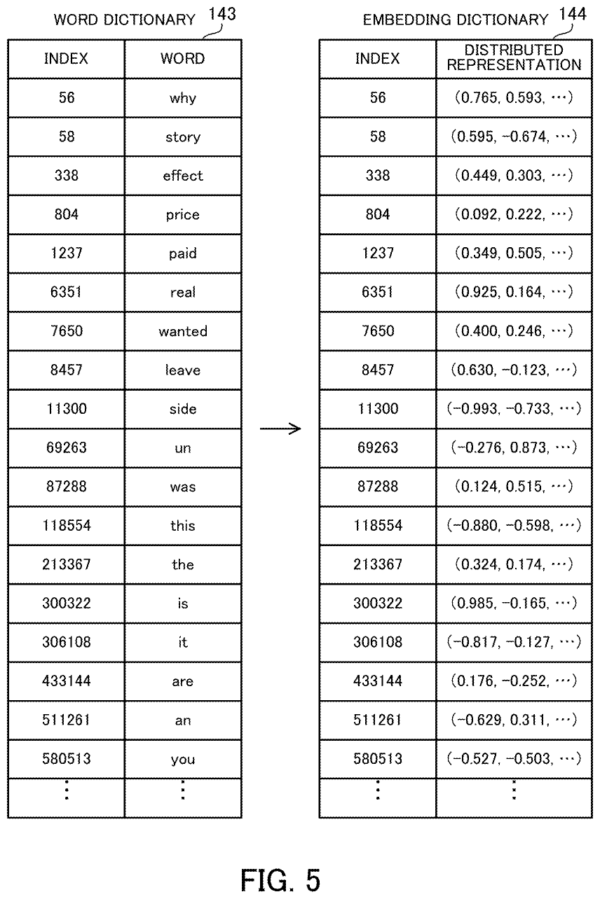

FIG. 5 illustrates an example of a word dictionary and embedding dictionary.

A word dictionary 143 is generated from the text 141. The word dictionary 143 is equivalent to the word dictionary 137 described above. The word dictionary 143 maps indices to strings of individual words. For example, the index for the word “why” is “56” and the index for the word “story” is “58”. The example of FIG. 5 depicts multiple words with discontinuous indices; however, continuous non-negative integers are given as indices to multiple words listed in the word dictionary 143.

The natural language processing model has an embedding dictionary 144 corresponding to the word dictionary 143. The embedding dictionary 144 is equivalent to the embedding dictionary 138 described above. The embedding dictionary 144 maps the indices to distributed representation vectors of the corresponding words. For example, the distributed representation vector with the index “56” is a distributed representation vector assigned to the word “why”. Similarly, for example, the distributed representation vector with the index “58” is a distributed representation vector assigned to the word “story”.

As mentioned above, the distributed representation vectors contained in the embedding dictionary 144 may change through machine learning. Note however that the size of the embedding dictionary 144 is determined by the size of the word dictionary 143. The distributed representation vectors contained in the embedding dictionary 144 may be obtained by reusing already learned distributed representation vectors indicated by an existing language model. In that case, the embedding dictionary 144 is generated based on the word dictionary 143.

Next described is machine learning for training a natural language processing model according to the second embodiment. When training the natural language processing model 130 depicted in FIG. 3, the information processor 100 extracts words from text for machine learning and generates the word dictionary 137. Using the index of each word indicated by the word dictionary 137, the information processor 100 converts the text into the encoded text 139. Subsequently, the information processor 100 initializes the natural language processing model 130 using the word dictionary 137 and the encoded text 139.

The initialization of the natural language processing model 130 includes parameter settings, such as determining a matrix size and the number of parameters. The initialization of the natural language processing model 130 also includes assigning initial values to the set parameters. For example, the input size of the neural network included in the embedding layer 131 depends on the number of words contained in the word dictionary 137. Therefore, the size of a weight matrix representing the neural network of the embedding layer 131 is determined according to the number of words in the word dictionary 137, that is, the maximum value of the indices. The information processor 100 generates a weight matrix of the determined size.

In addition, for example, the embedding dictionary 138 is generated in such a manner as to have the same number of indices as the word dictionary 137. When training the embedding layer 131 together with the self-attention layer 132 and the feedforward layer 134, temporary distributed representation vectors may be registered in the embedding dictionary 138 at the time of initialization. In the case of using an existing language model, already learned distributed representation vectors are registered in the embedding dictionary 138 by initialization. Further, for example, a probability distribution calculated by the prediction layer 136 includes as many prediction probabilities as the number of words in the word dictionary 137. The information processor 100 generates a probability distribution vector of the determined size.

The sizes of input tensors received by the embedding layer 131, the self-attention layer 132, the normalization layer 133, the feedforward layer 134, the normalization layer 135, and the prediction layer 136, for example, depend on the number of tokens that may be entered at one time. Therefore, the sizes of these input tensors are determined according to the number of tokens in the encoded text 139. The information processor 100 generates input tensors of the determined size.

The information processor 100 initializes the natural language processing model 130 using a machine learning library API. For example, the information processor 100 generates an object representing the natural language processing model 130, then connects the word dictionary 137 and the encoded text 139 to the object, and calls an API for initialization. As a result, the word dictionary 137 and the encoded text 139 are incorporated into the natural language processing model 130. Furthermore, the embedding dictionary 138 corresponding to the word dictionary 137 is generated in the natural language processing model 130.

However, the data size of the word dictionary 137 is very large because the word dictionary 137 contains string representations of many words. When the natural language processing model 130 is trained with the word dictionary 137 included, various additional processing takes place during machine learning. This may increase the load of machine learning, which would in turn lead to increased training time. For example, the information processor 100 may attempt to load the entire word dictionary 137 into memory, and may try to check as appropriate for the consistency between numerical values functioning as indices and the word dictionary 137 during machine learning.

On the other hand, updating of the parameter values after initialization is executable without referring to the word dictionary 137. The error calculation for the prediction results and the calculation of the error backpropagation gradients is capable of being performed using the indices and distributed representation vectors, and the embedding dictionary 138 and the encoded text 139 simply need to be included in the natural language processing model 130.

Therefore, after initializing the natural language processing model 130, the information processor 100 of the second embodiment detaches the word dictionary 137 from the natural language processing model 130 before starting the update of the parameter values. Herewith, the word dictionary 137 is deleted from the natural language processing model 130. The information processor 100 detaches the word dictionary 137 using a machine learning library API. For example, the information processor 100 calls an API to disconnect the object representing the natural language processing model 130 and the word dictionary 137.

When the word dictionary 137 is detached, various additional processing related to the word dictionary 137 is suppressed during machine learning. As a result, the load of machine learning is reduced, which in turn shortens the training time. For example, the information processor 100 suppresses loading of the word dictionary 137 into memory, and prevents checking as appropriate for the consistency between numerical values functioning as indices and the word dictionary 137 during machine learning.

Note however that the word predicted by the prediction layer 136 is represented as an index. If the natural language processing model 130 does not include the word dictionary 137, the index is not converted into a human-readable string. Therefore, when testing the trained natural language processing model 130, the information processor 100 uses the detached word dictionary 137 to convert the index included in the prediction results into a string representation of a word. This facilitates the user to understand the prediction results.

At this time, the information processor 100 may reincorporate the word dictionary 137 into the natural language processing model 130. The information processor 100 may use a machine learning library API to incorporate the word dictionary 137. For example, the information processor 100 calls an API that specifies the word dictionary 137 as a dictionary for converting an index into a string. Note that when distributing the trained natural language processing model 130, the natural language processing model 130 and the word dictionary 137 may be distributed separately, or together with the natural language processing model 130 including the word dictionary 137 therein.

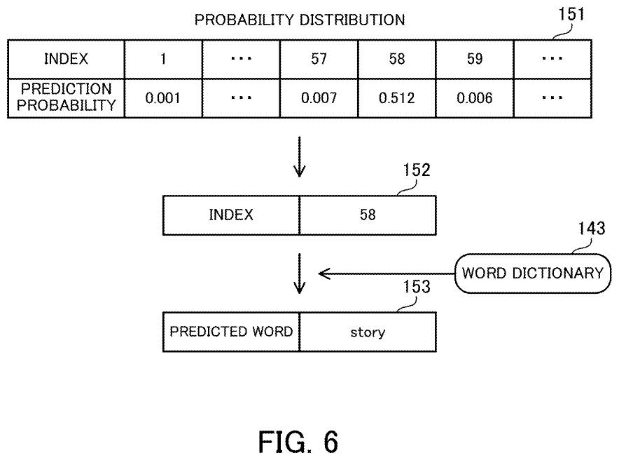

FIG. 6 illustrates an example of conversion of prediction results using a word dictionary.

The trained natural language processing model calculates a probability distribution 151 for a given token. The probability distribution 151 includes multiple prediction probabilities corresponding to multiple indices. Each prediction probability is a numerical value greater than or equal to 0 and less than or equal to 1. The prediction probability of a given index indicates the probability that the predicted word is the word mapped to the index.

The information processor 100 selects an index 152 with the highest prediction probability from the probability distribution 151. The information processor 100 refers to the word dictionary 143 to convert the index 152 into a predicted word 153. The predicted word 153 is a string representation of the word mapped to the index 152. For example, the index 152 is “58”, and the predicted word 153 is “story”. The information processor 100 outputs the predicted word 153.

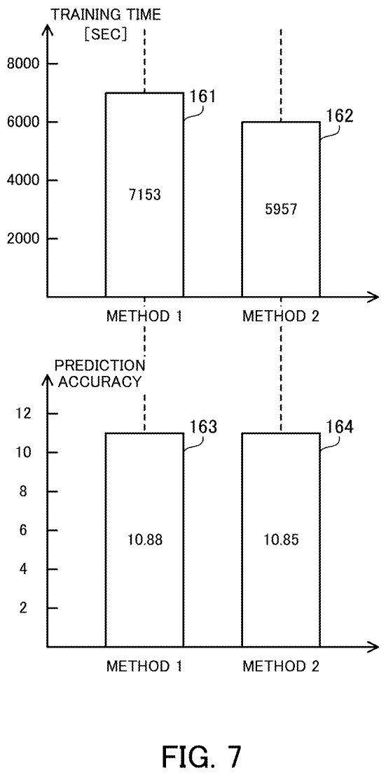

FIG. 7 is graphs illustrating an example of training time and prediction accuracy.

A bar 161 represents the time needed for training a natural language processing model without detaching a word dictionary (method 1). A bar 162 represents the time needed for training the natural language processing model by detaching the word dictionary (method 2). A bar 163 indicates the prediction accuracy of the natural language processing model in the method 1. A bar 164 indicates the prediction accuracy of the natural language processing model in the method 2.

In this example, the training time for the method 1 is 7153 seconds whereas the training time for the method 2 is 5957 seconds. Therefore, detaching the word dictionary improves the speed of machine learning by about 20%. Further, in this example, the prediction accuracy score of the method 1 is 10.88 whereas that of the method 2 is 10.85. Thus, between the method 1 and the method 2, there is no difference in prediction accuracy that exceeds the statistical error, and the prediction accuracy is thus maintained.

Next described are functions and processing procedures of the information processor 100.

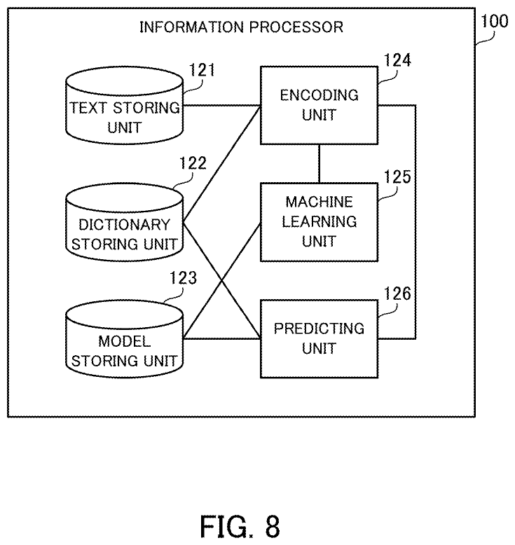

FIG. 8 is a block diagram illustrating an example of functions of an information processor.

The information processor 100 includes a text storing unit 121, a dictionary storing unit 122, a model storing unit 123, an encoding unit 124, a machine learning unit 125, and a predicting unit 126. The text storing unit 121, the dictionary storing unit 122, and the model storing unit 123 are implemented using, for example, the RAM 102 or the HDD 103. The encoding unit 124, the machine learning unit 125, and the predicting unit 126 are implemented using, for example, the CPU 101 or the GPU 104 and programs.

The text storing unit 121 stores therein text written in natural language. For example, the text storing unit 121 stores the text 141. The dictionary storing unit 122 stores a word dictionary generated from the text. For example, the dictionary storing unit 122 stores the word dictionary 143. The model storing unit 123 stores a trained natural language processing model. The model storing unit 123 stores, for example, the natural language processing model 130.

The encoding unit 124 reads the text from the text storing unit 121 and divides sentences included in the text into tokens. The encoding unit 124 aggregates the tokens, then generates a word dictionary that lists multiple different words, and stores the word dictionary in the dictionary storing unit 122. The encoding unit 124 also converts the string of each token into an index with reference to the word dictionary to thereby generate encoded text. The encoded text thus generated is, for example, the encoded text 142.

The encoding unit 124 provides the word dictionary to the machine learning unit 125. The encoding unit 124 also provides the machine learning unit 125 with training encoded text, which is a part of the encoded text used for training. In addition, the encoding unit 124 provides the predicting unit 126 with testing encoded text, which is a part of the encoded text used for testing.

The machine learning unit 125 trains the natural language processing model using the word dictionary and the training encoded text, and saves the trained natural language processing model in the model storing unit 123. At this time, the machine learning unit 125 initializes the natural language processing model using the word dictionary and the training encoded text. Then, the machine learning unit 125 detaches the word dictionary from the initialized natural language processing model. With the word dictionary detached, the machine learning unit 125 updates the parameter values of the natural language processing model by error backpropagation using the training encoded text.

The predicting unit 126 reads the word dictionary from the dictionary storing unit 122, and also reads the natural language processing model from the model storing unit 123. The predicting unit 126 enters the testing encoded text to the natural language processing model and acquires prediction results. The predicting unit 126 converts the index of a word included in the prediction results into a string representation using the word dictionary. Subsequently, the predicting unit 126 outputs the prediction results including the string of the word.

Note that the information processor 100 may display the natural language processing model on the display device 111 and/or transmit it to different information processors. Further, the information processor 100 may store the prediction results of the natural language processing model in a non-volatile storage device; display them on the display device 111; and/or transmit them to different information processors.

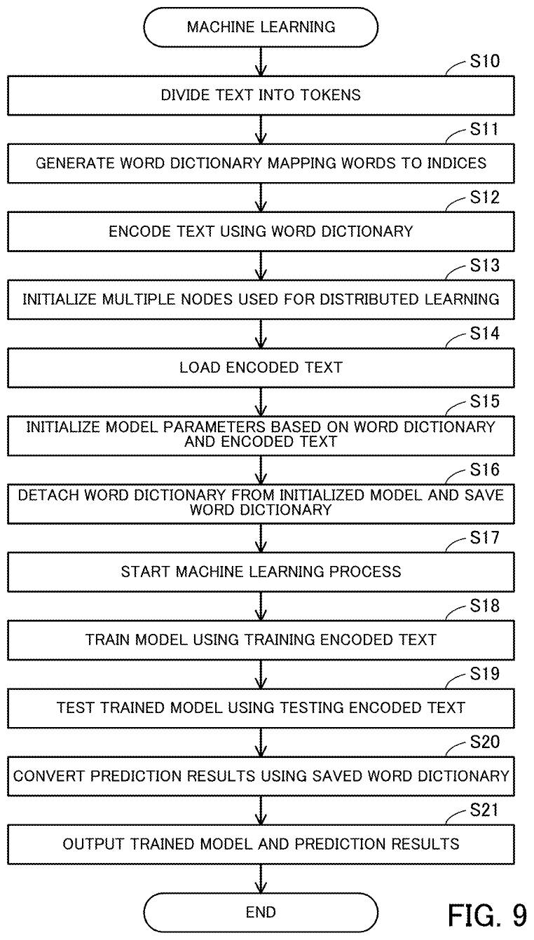

FIG. 9 is a flowchart illustrating an example of a machine learning procedure.
(Step S10) The encoding unit 124 divides text into tokens.
(Step S11) The encoding unit 124 aggregates the tokens divided in step S10 and generates a word dictionary in which words are mapped to indices.
(step S12) The encoding unit 124 encodes strings of the text into indices using the word dictionary to thereby generate encoded text.
(Step S13) When machine learning is implemented as distributed processing, the machine learning unit 125 initializes multiple nodes used for the machine learning. Each node includes a processor for running a machine learning process, and includes, for example, a GPU core. In that case, the machine learning unit 125 sets communication ports for the multiple nodes to enable message communication between the nodes.
(Step S14) The machine learning unit 125 loads the encoded text generated in step S12. Memory into which the encoded text is loaded is, for example, the RAM 102 or GPU memory.
(Step S15) Based on the word dictionary generated in step S11 and the encoded text loaded in step S14, the machine learning unit 125 initializes the parameters of the natural language processing model. The initialization includes generating matrices according to the size of the word dictionary and the size of the encoded text and assigning initial values to the parameters. The initialization also includes generating an embedding dictionary with the same number of indices as the word dictionary. Note that when the embedding layer is not a training target, the machine learning unit 125 may convert indices included in the encoded text into distributed representation vectors during the initialization.
(Step S16) The machine learning unit 125 detaches the word dictionary from the natural language processing model initialized in step S15 and saves the detached word dictionary.
(Step S17) The machine learning unit 125 starts a machine learning process. At this time, the machine learning unit 125 calls, for example, a machine learning library API.
(Step S18) Using training encoded text, the machine learning unit 125 trains the natural language model, from which the word dictionary has been detached. For example, the machine learning unit 125 inputs each index included in the training encoded text to the embedding layer, calculates the error between the probability distribution calculated by the prediction layer and the correct index, and updates the parameter values for each layer in such a manner as to reduce the error.
(Step S19) The predicting unit 126 tests the trained natural language processing model using the testing encoded text. For example, the predicting unit 126 inputs each index included in the testing encoded text into the embedding layer and acquires the prediction results including the index of a word.
(Step S20) Using the word dictionary saved in step S16, the predicting unit 126 converts the index included in the prediction results of step S19 into a string representation.
(Step S21) The information processor 100 outputs the natural language processing model trained in step S18 and the prediction results converted in step S20. Note that if the user decides that the prediction accuracy is insufficient, they may instruct the information processor 100 to further tune the parameter values. In that case, the information processor 100 may repeat steps S17 to S21. At that time, additional encoded text may be used.

As has been described above, after initializing the natural language processing model based on the word dictionary and encoded text, the information processor 100 of the second embodiment detaches the word dictionary from the natural language processing model and then updates the parameter values based on the encoded text. This enables a reduction in the data size of the natural language processing model and reduces the load of the machine learning, which in turn shortens the training time. In addition, updating the parameter values so as to reduce the error is feasible without referring to the word dictionary. Therefore, the prediction accuracy of the natural language processing model is preserved.

In addition, when predicting words using the trained natural language processing model, the information processor 100 converts indices used inside the natural language processing model into string representations of words using the detached word dictionary. This improves the ease of understanding of the prediction results.

According to one aspect, it is possible to reduce the time for training the natural language processing model.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A machine learning method comprising:
acquiring, by a processor, word dictionary data in which strings each representing one of a plurality of words used in a natural language are mapped to codes each identifying one of the plurality of words;
converting, by the processor, text data written in the natural language into encoded text data by encoding words included in the text data based on the word dictionary data;
initializing, by the processor, parameters included in a machine learning model based on the word dictionary data and the encoded text data; and
running, by the processor, a learning process to train, based on the encoded text data, the machine learning model from which the word dictionary data has been detached after the initializing of the parameters.

2. The machine learning method according to claim 1, further comprising:
acquiring, by the processor, prediction result data including the code of at least one of the plurality of words by entering input data to the machine learning model after the learning process and converting, based on the word dictionary data, the code included in the prediction result data into the string representing the at least one of the plurality of words.

3. The machine learning method according to claim 1, wherein:
the initializing of the parameters includes setting, in the machine learning model, distributed representation data in which distributed representation vectors each assigned to one of the plurality of words are mapped to the codes, and
the machine learning model includes an embedding layer for converting the codes included in the encoded text data into the distributed representation vectors.

4. A non-transitory computer-readable recording medium storing therein a computer program that causes a computer to execute a process comprising:
acquiring word dictionary data in which strings each representing one of a plurality of words used in a natural language are mapped to codes each identifying one of the plurality of words;
converting text data written in the natural language into encoded text data by encoding words included in the text data based on the word dictionary data;
initializing parameters included in a machine learning model based on the word dictionary data and the encoded text data; and
running a learning process to train, based on the encoded text data, the machine learning model from which the word dictionary data has been detached after the initializing of the parameters.

5. An information processing apparatus comprising:
a memory configured to store word dictionary data in which strings each representing one of a plurality of words used in a natural language are mapped to codes each identifying one of the plurality of words and text data written in the natural language; and
a processor coupled to the memory and the processor configured to:
convert the text data into encoded text data by encoding words included in the text data based on the word dictionary data,
initialize parameters included in a machine learning model based on the word dictionary data and the encoded text data, and
run a learning process to train, based on the encoded text data, the machine learning model from which the word dictionary data has been detached after initializing the parameters.
